(19) United States
(12) Patent Application Publication
(10) Pub. No.: US 2004/0025710 A1
(43) Pub. Date: Feb. 12, 2004

(54) Wok with multiple built-in shaper-bowl cookers

(76) Inventor: James Conley, Chicago, IL (US)

Correspondence Address: Donald W. Meeker, 924 East Ocean Front, #E, Newport Beach,, CA, 92661, US

(21) Appl. No.: 10/218,324

(22) Filed: Aug. 12, 2002

(51) Int. Cl. A47J 37/10

(52) U.S. Cl. 99/422; 99/448

(57) ABSTRACT

A wok with multiple bowls has a regularly sized and shaped main bowl with a number of additional smaller bowls built within the perimeter and raised slightly above the bottom of the larger bowl to permit cooking of a number of different ingredients for one dish or several different dishes at the same time in the same wok. A normal wok dish may be cooked in the larger bowl adaptable to any number of people and the smaller bowls may be used to simultaneously cook individual portions, components of one dish or several different dishes that should be restrained while cooking to prevent spreading that will occur in many egg dishes such as Chinese egg fu-yung patties.

### BACKGROUND OF THE INVENTION

1. Field of the Invention

The present invention relates to cooking apparatus and in particular to a wok with multiple bowls having a primary wok bowl and a number of smaller built-in shaper wok bowls built within the larger wok bowl.

2. Description of the Prior Art

Cooking food in a wok is an ancient art. The vessel serves many functions and therefore replaces many Western utensils. A single wok is normally about fourteen inches in diameter and is made of carbon steel or other metals including stainless steel, cast iron, aluminum and copper.

The basic techniques of wok cooking include stir-frying, deep frying and steaming. Stir-frying involves cooking pre-cut pieces of food in small amounts of oil over high heat for short periods of time. Deep frying involves the use of considerably more oil than stir-frying, but this oil, rather than the hot surface of the wok, acts as the heat-transfer medium. The oil should be heated to approximately 375° degrees before the food is added. Surprising and pleasing results can often be achieved with this method, In steaming, the wok is used as a water vessel in which either a perforated aluminum tray or bamboo basket is placed. The food platter is placed on top of the tray or basket, covered and steamed over high heat.

When cooking with a wok in the conventional manner, foodstuffs composing a meal are often cooked together long enough for them to lose their shape and unique individual taste so as to become an agglomeration similar to chop suey. Hence, flavors of the ingredients exchange with each other such that all of the components of the meal may have the same taste.

In cooking egg dishes and other types of dishes, it is often undesirable to have the egg or other liquid type food expand outwardly over too large an area and thin out the food too much.

It should be apparent, that it would be highly beneficial to a cook or chef if provision were made in a wok to offer the option of cooking several ingredients together in the bowl of the wok while isolating some ingredients that have been previously cooked or which are simply being pre-heated in readiness for being introduced in the mixture within the wok bowl or which require more confinement in cooking than the large wok bowl provides or which should be cooked in smaller quantities. It would also be beneficial if foodstuffs could be cooked in a smaller confined area concurrently with but separate from the foodstuffs being cooked in the main wok bowl.

U.S. Pat. No. 5,385,085, issued Jan. 31, 1995 to Robert A. Piane, Sr., provides a multiple unit wok apparatus is provided for simultaneously cooking separate ingredients and, when cooked, the ingredients can be easily mixed together if desired. The individual wok units are attached together.

U.S. Pat. No. 4,666,727, issued May 19, 1987 to Gung H. Wang, shows a method of wok cooking in a utensil having a generally flat bottom cooking area and a generally upwardly facing food retaining shoulder which is elevated alongside the cooking area and extends toward an upwardly extending wall, comprises cooking the food on the cooking area and shifting cooked food from the cooking area onto the shoulder means on which the food is drained of cooking oil and kept warm. Also disclosed is an improved multi-hump shoulder structure with oil drainage channels.

U.S. Pat. No. 2,722,173, issued Nov. 1, 1955 to V. Cunningham, claims a double frying pan which can be used for frying or poaching eggs.

U.S. Pat. No. 5,511,466, issued Apr. 30, 1996 to DuWayne M. Dzibinski, describes an annular trough is formed integrally with the rim of a bowl-like wok to provide a place to store and cook ingredients individually while one or more other ingredients are being cooked in the bowl. A cover used in combination with the wok is comprised of sheet metal formed as a truncated hemispherical configuration by metal spinning techniques. The cover mates with the wok in such manner that there is an annular passageway or gap that provides for convection of heat from the bowl of the wok to the trough for keeping ingredients stored therein warm or for cooking other ingredients that are stored in the trough. The cover covers the entire radial width of the trough.

U.S. Pat. No. 6,065,393, issued May 23, 2000 to Lombard et al., discloses an apparatus is provided for use in cooking a number of separate articles such as eggs. In one embodiment of the apparatus, internal walls (14) extend radially between inner (12) and outer (10) circular walls, defining separate compartments (18). In other embodiments, individual cooking rings (34, 58, 68, 102, 106) are attachable releasably to a central holder (40, 48, 60, 74, 84), and can move relative to the holder so that the apparatus can be used on a curved cooking surface.

U.S. Pat. No. 6,186,055, issued Feb. 13, 2001 to Robert A. DeMars, indicates a turntable cooking and serving appliance which utilizes a substantially planer base within which is centrally mounted a pan. The pan includes an electrically operated heating element. A cooking vessel is to be removably locatable within the pan. An annular compartment surrounds the pan. A ring is mounted within the annular compartment with a bearing assembly being located between the ring and the floor of the annular compartment. A plurality of trays are locatable within the annular compartment and are adapted to rest on the ring and to be rotatable therewith. Each tray is to contain food with food also to be cooked within the cooking vessel.

U.S. Pat. No. 3,439,603, issued Apr. 22, 1969 to R. L. Reames, puts forth a cooking pan having a supplemental peripherally extending food supporting rack including a coextensive upwardly extending slotted drain rim and downwardly extending locking lip engaging the inner pan periphery for retaining the rack in position on the pan.

U.S. Pat. No. 5,988,045, issued Nov. 23, 1999 to Todd B. Housley, concerns a utensil supporting multiple cooking environments for preparing foods is disclosed in one presently preferred embodiment of the present invention as including a cooking grill and a cover member selectively disposed in relation to a base unit comprising one or more cooking compartments. The cooking grill having a cooking surface and a collection reservoir disposed beneath at least a portion of the cooking surface. Formed in the upper cooking surface of the cooking grill are a plurality of openings. Collection channels may also be disposed along the upper cooking surface so as to provide device for feeding run-off liquids through the openings and into the underlying collection reservoir of the cooking grill. Having a dimensional size and shape substantially corresponding to the outer perimeter of the base unit, the cooking grill, when selectively disposed over the internal periphery of the base unit, facilitates a first cooking environment within the base unit. The air generally sealed within the first cooking environment may circulate around the food items retained within the various cooking compartments to provide device for preparing the food items contained therein. The cooking grill supports a second cooking environment for preparing foods, wherein liquids (i.e., water, oil, grease, etc.) may be collected from those food items disposed on or suspended above the upper cooking surface of the cooking grill. Depending upon whether the cover member is selectively positioned in supportable relation to the base unit and over the cooking grill, the second environment may facilitate the preparation of food items by means of grilling, baking, roasting and/or broiling. In addition, water may be introduced into the collection reservoir of the cooking grill to provide device for steaming the food item(s) disposed within the second environment.

What is needed is a multi-bowl wok type cooking vessel having a number of different cooking bowls built into the same vessel.

### SUMMARY OF THE INVENTION

An object of the present invention is to provide a wok with multi-bowls having a primary large bowl for normal wok cooking with varying quantities of food and to provide a number of additional smaller bowls held within the perimeter and raised slightly above the bottom of the larger bowl for cooking individual smaller portions of food and food requiring shaping that might expand too much in a larger bowl, such as those that use egg.

Another object of the present invention is to provide a wok that has the capability of permitting cooking foodstuffs in sequence or in any combination concurrently and that provides for keeping foodstuffs inside individual smaller bowls, isolated from one another in readiness for being cooked individually within the wok or in a mixture of foodstuffs in the larger bowl of the wok simultaneously.

An additional object of the present invention is that foodstuff components of a meal can be cooked entirely in the smaller food shapers while the base ingredient of the meal or other foodstuffs are being cooked in the main bowl. For example, when water is boiling in the larger bowl for components such as rice or meat, other foodstuffs can be cooked in the smaller food shapers, such as vegetable components to be added at differing times.

A corollary object of the present invention is the reverse situation. Individual foodstuffs or combinations of foodstuffs can be cooked in the larger bowl of the wok and then stored in the smaller shaper bowls separately from each other to preserve individual flavor and texture characteristics for subsequent steps in a recipe.

A subsequent object of the present invention is that foodstuffs residing in the smaller food shapers cook rapidly by convection of steam and radiation of heat derived from the larger bowl.

A further object of the present invention is to provide a means for a cook to conveniently and easily employ more than one method of wok cooking simultaneously.

An associated object of the present invention is to provide a wok whose versatility is limited only by limitations of the creativity of the cook.

Yet another object of the present invention is to provide two frying areas, a shaping frying area and a regular frying area for mixing and other space requiring styles of cooking.

An auxiliary object of the present invention is to provide smaller shape fryer areas to fry food that may be dispersed easily during cooking.

A contributory object of the present invention is to provide more than two handles in order to manipulate the contents of the entire unit in varying ways and degrees.

An ancillary object of the present invention is to provide a drip edge for excess oil or other liquid to be gathered or drained when food contents are shifted from bowl to bowl.

In brief, a wok with multiple bowls has a regularly sized and shaped main bowl with a number of additional smaller shaping bowls built within the perimeter and raised slightly above the bottom of the larger bowl to permit cooking of a number of different ingredients for one dish or several different dishes at the same time in the same wok.

A normal wok dish may be cooked in the larger bowl adaptable to any number of people and the smaller bowls may be used to simultaneously cook individual portions, components of one dish or several different dishes that should be restrained while cooking to prevent spreading that will occur in many egg dishes such as Chinese egg fu-yung patties.

An advantage of the present invention is to provide a wok with multi-bowls having a primary large bowl and a number of additional smaller bowls for cooking individual smaller portions of food and food requiring shaping.

Another advantage of the present invention is to provide a wok that has the capability of permitting cooking foodstuffs in sequence or in any combination concurrently.

An additional advantage of the present invention is to provide for foodstuff components of a meal to be cooked entirely in the smaller food shapers while the base ingredient of the meal or other foodstuffs are being cooked in the main bowl.

A further advantage of the present invention is the reverse situation. Individual foodstuffs or combinations of foodstuffs can be cooked in the larger bowl of the wok and then stored in the smaller shaper bowls separately from each other.

One more advantage of the present invention is that foodstuffs residing in the smaller food shapers cook rapidly.

Yet another advantage of the present invention is to provide a means for a cook to conveniently and easily employ more than one method of wok cooking simultaneously.

Still another advantage of the present invention is to provide a wok whose versatility is limited only by limitations of the creativity of the cook.

A successive advantage of the present invention is to provide two frying areas, a shaping frying area and a regular frying area.

An extra advantage of the present invention is to provide smaller shape fryer areas to fry food that may be dispersed easily

A different advantage of the present invention is to provide more than two handles in order to manipulate the contents of the entire unit in varying ways and degrees.

A next advantage of the present invention is to provide a drip edge for excess oil or other liquid to be gathered or drained.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a top plan view of the invention;

FIG. 2 is a cross-sectional view taken through 2-2 of FIG. 1.

### BEST MODE FOR CARRYING OUT THE INVENTION

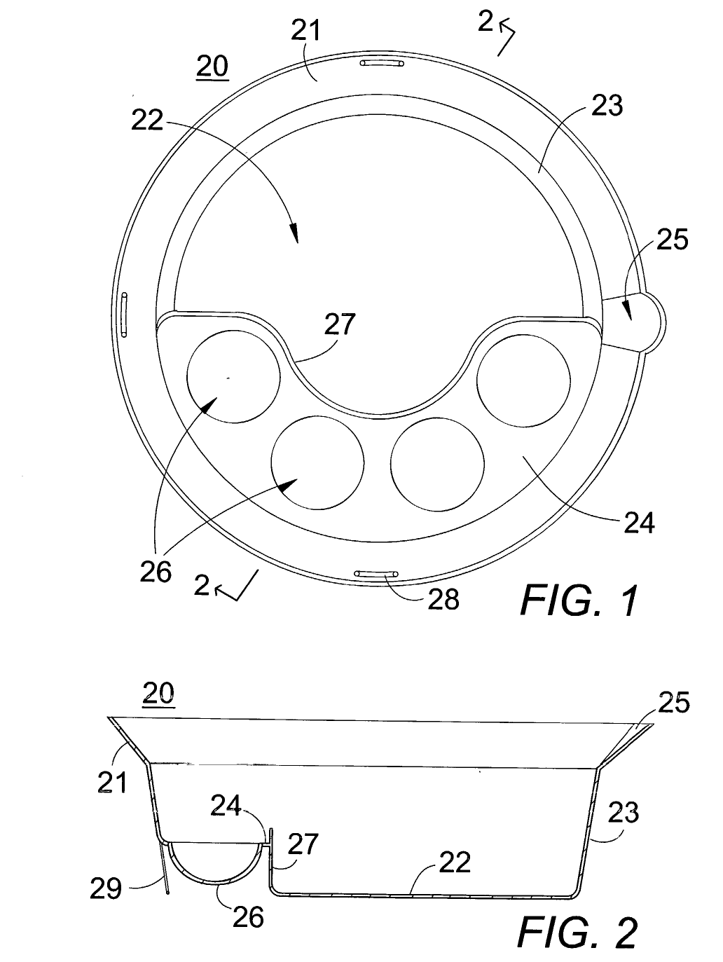

In FIGS. 1-2, a multi-bowl wok 20 with a multiplicity of cooking bowls contained in one wok is comprised of a wok having a primary bowl 22 capable of conventional wok cooking and at least one additional secondary bowl 26, but in a preferred embodiment, preferably four secondary bowls 26, built into the primary bowl 22. The secondary bowls 26 each have a more confined area than the primary bowl 22 and are capable of shaped wok cooking, such as cooking with ingredients that would spread out too much if placed in the primary bowl, like egg.

In FIGS. 1-2, the secondary bowls 26 are built into the primary bowl 22 and each has a more confined area than the primary bowl 22 so that the secondary bowls 26 are each capable of shaped wok cooking.

In FIGS. 1-2, an outer wall 23 surrounds a portion of the primary cooking area 22 and the primary bowl has a bottom cooking surface 22 which comprises at least half of the cooking area of the multi-bowl wok 20. The primary bowl bottom cooking surface 22 is capable of being exposed to a heat source below the primary bowl bottom cooking surface 22 for cooking thereon.

In FIGS. 1-2, a secondary bowl support surface 24 is elevated above the bottom of the primary bowl 22 and is adjacent to it. The secondary bowl support surface 24 has a wall surface 27 extending downwardly to the primary bowl bottom cooking surface 22 completing this encircling of the primary cooking bowl along with the outer wall 23. A series of spaced secondary bowls 26 are recessed in the support surface 24. Each of the secondary bowls 26 has a confining wall surface and a secondary bowl bottom cooking surface capable of being exposed to a heat source below the secondary bowl bottom cooking surface for cooking thereon. Preferably, the secondary bowls 26 are comprised of a half dome surface recessed in the secondary bowl support surface, the half dome surface forming both the confining wall and the bottom cooking surface.

In FIGS. 1-2, a drip pour spout 25 is built into a lip 21 around a top edge of the wall 23 surrounding the cooking area found in between the primary bowl 22 and the secondary bowl support 24. The drip pour spout 25 is capable of receiving liquid from the primary bowl and the secondary bowls.

In FIGS. 1-2, a support frame 29, preferably of strong wire is built into the multi-bowl wok below the secondary bowl support 24. The bottom of the support frame 24 is aligned with the primary bowl bottom cooking surface 22.

In FIG. 1, at least two handles 28, preferably three, are attached to the wall surrounding the cooking area, preferably on the lip 21, for handling the wok.

In FIGS. 1-2, preferably the wall 23 surrounding the cooking area is circular, imitating the style of conventional woks.

The entire multi-bowl wok is preferably fabricated of stainless steel or other conventional metal used in woks with the parts welded together.

It is understood that the preceding description is given merely by way of illustration and not in limitation of the invention and that various modifications may be made thereto without departing from the spirit of the invention as claimed.

What is claimed is:

1. A multi-bowl wok providing a multiplicity of cooking bowls in one wok, the multi-bowl wok comprising:
a wok having a primary bowl capable of conventional wok cooking;
at least one additional secondary bowl built into the primary bowl, the at least one secondary bowl having a more confined area than the primary bowl, the at least one secondary bowl being capable of shaped wok cooking.

2. The multi-bowl wok of claim 1 wherein a multiplicity of secondary bowls are built into the primary bowl, the secondary bowls each having a more confined area than the primary bowl and the secondary bowls each being capable of shaped wok cooking.

3. The multi-bowl wok of claim 1 wherein the multi-bowl comprises a wall surrounding a cooking area and the primary bowl comprises a bottom cooking surface which comprise at least half of the cooking area of the multi-bowl wok, the primary bowl bottom cooking surface capable of being exposed to a heat source below the primary bowl bottom cooking surface for cooking thereon and further comprising a secondary bowl support surface elevated above a bottom of the primary bowl adjacent to the primary bowl, the secondary bowl support surface having a wall surface extending downwardly to the primary bowl bottom cooking surface and having a series of spaced secondary bowls recessed in the support surface, each of the secondary bowls having a confining wall surface and a secondary bowl bottom cooking surface capable of being exposed to a heat source below the secondary bowl bottom cooking surface for cooking thereon.

4. The multi-bowl wok of claim 3 wherein each of the secondary bowls comprises a half dome surface recessed in the secondary bowl support surface.

5. The multi-bowl wok of claim 3 further comprising a drip pour spout built into a top edge of the wall surrounding the cooking area, the drip pour spout capable of receiving liquid from the primary bowl and the secondary bowls.

6. The multi-bowl wok of claim 3 further comprising a support frame below the secondary bowl support, a bottom of the support frame being aligned with the primary bowl bottom cooking surface.

7. The multi-bowl wok of claim 3 further comprising at least two handles attached to the wall surrounding the cooking area for handling the wok.

8. The multi-bowl wok of claim 3 wherein the wall surrounding the cooking area is circular.
